(19) United States
(12) Patent Application Publication
(10) Pub. No.: US 2026/0262572 A1
(43) Pub. Date: Sep. 10, 2026

(54) AIRFLOW SYSTEM FOR AN AGRICULTURAL HARVESTER ROW UNIT

(71) Applicants: CNH Industrial Canada, Ltd., Saskatoon (CA); CNH Industrial America LLC, New Holland, PA (US)

(72) Inventors: Arshjot Brar, Saskatoon (CA); Eric Underwood, McCune, KS (US)

(21) Appl. No.: 19/555,487

(22) Filed: Mar. 3, 2026

Related U.S. Application Data
(60) Provisional application No. 63/767,696, filed on Mar. 6, 2025.

(51) Int. Cl. A01D 46/10; A01D 57/01

(52) U.S. Cl. CPC A01D 46/10; A01D 57/01

(57) ABSTRACT

An airflow system of a row unit of an agricultural harvester includes a jet post that receives air from an air source. The jet post has an air outlet directed toward an agricultural product outlet of the row unit, and the air outlet outputs the air to drive agricultural product toward the agricultural product outlet. The airflow system also includes an airflow path extending from the jet post. The airflow path receives the air from the jet post, the airflow path is positioned below a floor of the row unit, and the airflow path expels the air through at least one opening in the floor. Furthermore, the airflow system includes at least one louver coupled to the floor at the at least one opening. The at least one louver directs the air toward the agricultural product outlet.

### CROSS-REFERENCE TO RELATED APPLICATION

This application claims priority from and the benefit of U.S. Provisional Application Serial No. 63/767,696, entitled “AIRFLOW SYSTEM FOR AN AGRICULTURAL HARVESTER ROW UNIT”, filed March 6, 2025, which is hereby incorporated by reference in its entirety.

### FIELD OF THE DISCLOSURE

The present disclosure relates generally to an airflow system of an agricultural harvester row unit.

### BACKGROUND

Agricultural harvesters are used to harvest agricultural products (e.g., cotton or other natural material(s)). For example, an agricultural harvester may include a header having row units configured to harvest the agricultural product from a field. The agricultural harvester may also include an air-assisted conveying system configured to move the agricultural product from the row units to an accumulator. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

Certain row units include two rotors, and each rotor includes multiple spindles (e.g., barbed spindles) configured to engage a crop (e.g., a cotton plant). The rotors may be positioned on opposite sides of a crop path through the row unit or on the same side of the crop path, and the spindles extend into the crop path. During operation of the agricultural harvester, the row unit is positioned to align a row of crops with the crop path. Accordingly, as the agricultural harvester traverses the field, the spindles of the rotors engage each plant of the row. The rotors are driven to rotate, such that engagement of the spindles with the crop separates the agricultural product (e.g., seed cotton) from the plant stalk. The agricultural product collects on the spindles and is removed from the spindles by doffers, which are positioned adjacent to the rotors. The air-assisted conveying system moves the agricultural product from the row unit to the accumulator. After the agricultural product is removed from the spindles of each rotor, the spindles pass through a respective moistener column assembly to remove buildup of crop liquids (e.g., sap, etc.) from the spindles. Rotation of the rotors then drives the spindles to engage a subsequent crop. Unfortunately, the agricultural product may accumulate within regions between the doffers and an agricultural product outlet of the row unit, thereby plugging the row unit with the agricultural product. As a result, flow of the agricultural product from the row unit to the accumulator may be substantially reduced or terminated.

### BRIEF DESCRIPTION

In certain embodiments, an airflow system of a row unit of an agricultural harvester includes a jet post that receives air from an air source. The jet post has an air outlet directed toward an agricultural product outlet of the row unit, and the air outlet outputs the air to drive agricultural product toward the agricultural product outlet. The airflow system also includes an airflow path extending from the jet post. The airflow path receives the air from the jet post, the airflow path is positioned below a floor of the row unit, and the airflow path expels the air through at least one opening in the floor. Furthermore, the airflow system includes at least one louver positioned remote from the air outlet of the jet post. The at least one louver is coupled to the floor at the at least one opening, and the at least one louver directs the air toward the agricultural product outlet.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural harvester having a header.

FIG. 2 is a schematic top view of an embodiment of a row unit that may be employed within the header of FIG. 1.

FIG. 3 is a perspective view of an embodiment of an airflow system that may be employed within the row unit of FIG. 2.

FIG. 4 is a cross-sectional view of a portion of the airflow system of FIG. 3.

FIG. 5 is a block diagram of an embodiment of an airflow control system that may be employed within the airflow system of FIG. 3.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

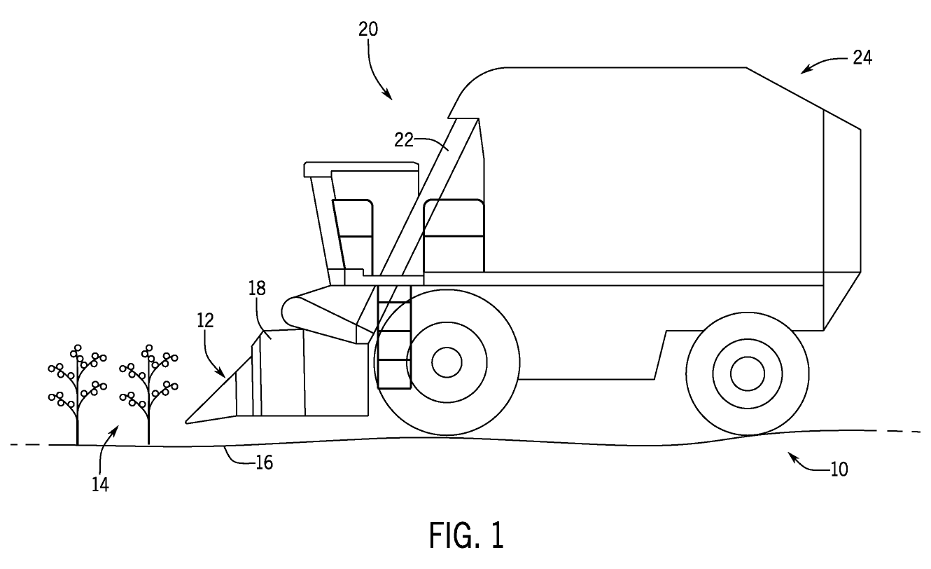

FIG. 1 is a side view of an embodiment of an agricultural harvester 10 having a header 12. The agricultural harvester 10 harvests agricultural product 14 (e.g., seed cotton) from a field 16 and forms the agricultural product 14 into bales (e.g., agricultural bales). In the illustrated embodiment, the header 12 of the agricultural harvester 10 includes multiple row units 18 distributed across the width of the header 12. Each row unit 18 harvests a respective row of the agricultural product 14 from the field 16. Additionally, the agricultural harvester 10 includes an agricultural product transport assembly 20 having an air-assisted conveying system 22 that moves the agricultural product 14 from the row units 18 of the header 12 to an accumulator of the agricultural product transport assembly 20. The agricultural product transport assembly 20 also includes a conveying system that conveys the agricultural product 14 from the accumulator into a baler 24. The baler 24 is supported by and/or mounted within or on a chassis of the agricultural harvester 10. The baler 24 may form the agricultural product 14 into round bales. However, in other embodiments, the baler 24 of the agricultural harvester 10 may form the agricultural product into square bales, polygonal bales, or bales of other suitable shape(s). After forming the agricultural product 14 into a bale, a bale wrapping system of the agricultural harvester 10 wraps the bale with a bale wrap to secure the agricultural product 14 within the bale and to generally maintain a shape of the bale.

As discussed in detail below, each row unit 18 includes two rotors positioned on opposite sides of a crop path through the row unit 18 or on the same side of the crop path. Each rotor includes multiple spindles (e.g., barbed spindles) extending into the crop path, and the spindles engage a crop (e.g., cotton plant) along a substantial portion of the height of the crop. During operation of the agricultural harvester 10, the crop path of the row unit 18 is aligned with a row of crops. Accordingly, as the agricultural harvester 10 traverses the field 16, the row unit 18 receives each crop of the row, and the spindles of the rotors engage the crop. The rotors are driven to rotate, such that engagement of the spindles with the crop separates the agricultural product (e.g., seed cotton) from the plant stalk (e.g., the crop after the agricultural product is removed). The agricultural product removed from the crop collects on the spindles, and the agricultural product is removed from the spindles by doffers. Each doffer directs the agricultural product to a respective conveying chamber, and the air-assisted conveying system 22 moves the agricultural product from the conveying chambers to the accumulator. After the agricultural product is removed from the spindles of each rotor, the spindles pass through a respective moistener column assembly to remove buildup of crop liquids (e.g., sap, etc.) from the spindles. As the rotors continue to rotate, the spindles engage a subsequent crop at the crop path.

In certain embodiments, each row unit 18 includes an airflow system having a jet post that receives air from an air source. The jet post has an air outlet directed toward an agricultural product outlet of the row unit, in which the air outlet outputs the air to drive the agricultural product toward the agricultural product outlet. Unfortunately, under certain conditions (e.g., high yield, high moisture content of the agricultural product, etc.), the air output by the air outlet of the jet post may be insufficient to drive the agricultural product through the agricultural product outlet. Accordingly, in certain embodiments, the airflow system includes an airflow path extending from the jet post, in which the airflow path receives the air from the jet post. The airflow path is positioned below a floor of the row unit, and the airflow path expels the air through at least one opening in the floor. In addition, the airflow system includes at least one louver positioned remote from the air outlet of the jet post (e.g., downstream from the air outlet along a flow direction of the agricultural product from a doffer to the agricultural product outlet). The at least one louver is coupled to the floor at the at least one opening, and the at least one louver directs the air toward the agricultural product outlet. The additional air provided by the airflow path may drive the agricultural product through the agricultural product outlet, thereby substantially reducing or eliminating the possibility of accumulation of the agricultural product within the row unit.

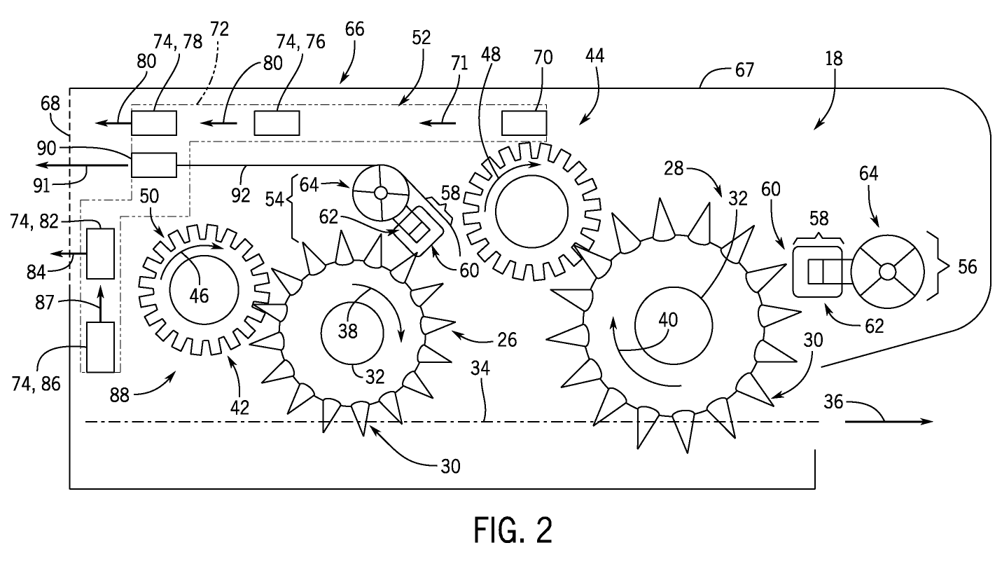

FIG. 2 is a schematic top view of an embodiment of a row unit 18 that may be employed within the agricultural harvester 10 of FIG. 1. In the illustrated embodiment, the row unit 18 includes a first rotor 26 and a second rotor 28. As illustrated, each rotor includes multiple spindles 30 (e.g., barbed spindles) that engage a crop (e.g., cotton plant). Each rotor rotates about a respective central shaft 32 (e.g., rotor shaft). In addition, each rotor includes two end structures rotatably coupled to the central shaft and multiple spindle bars rotatably coupled to the end structures. The spindle bars extend along a vertical axis of the row unit 18, the spindle bars are circumferentially distributed (e.g., evenly circumferentially distributed) about the end structures, and each spindle bar supports multiple spindles. The spindles 30 extend radially outward from each spindle bar, the spindles 30 coupled to each spindle bar are distributed along the vertical axis of the row unit 18, and the spindles 30 coupled to each spindle bar point in the same direction. Because the spindles 30 are distributed along the vertical axis, the spindles 30 engage the crop along a substantial portion of the height of the crop. Furthermore, an orientation control arm is coupled to each spindle bar, a roller is coupled to an end of each orientation control arm, and the rollers engage a cam track. The cam track controls the orientation of each spindle bar relative to the end structures as the rotor rotates, thereby controlling an orientation of the spindles with respect to the crop, with respect to a doffer, and with respect to a moistener column assembly. In addition, each spindle 30 is driven to rotate relative to the respective spindle bar. For example, a spindle drive gear may be coupled to each spindle bar, a spindle gear may be coupled to each spindle, the spindle drive gear may be driven to rotate by rotation of the rotor, and the spindle drive gear may drive the spindle gears to rotate, thereby rotating each spindle. As each spindle engages the agricultural product, rotation of the spindle drives the barbs to capture the agricultural product (e.g., seed cotton), such that the agricultural product wraps around the spindle.

In the illustrated embodiment, the first rotor 26 and the second rotor 28 are positioned on the same side of a crop path 34 through the row unit 18, and the spindles 30 of each rotor extend into the crop path 34. During operation of the agricultural harvester, the crop path 34 of the row unit 18 is aligned with a row of crops. Accordingly, as the agricultural harvester traverses the field along a direction of travel 36, the row unit 18 receives each crop of the row, and the spindles 30 of each rotor engage the crop. The first rotor 26 is driven to rotate in a first rotor rotational direction 38, and the second rotor 28 is driven to rotate in a second rotor rotational direction 40, which is the same direction as the first rotor rotational direction 38. The rotational speed of each rotor may be selected such that the tangential speed of the spindles 30 due to rotation of the rotor is equal to the ground speed of the row unit 18 along the direction of travel 36, thereby enabling the spindles 30 to engage the crop at a substantially zero relative speed. Engagement of the spindles 30 with the crop separates the agricultural product (e.g., seed cotton) from the plant stalk (e.g., the crop after the agricultural product is removed). While the first and second rotors are positioned on the same side of the crop path in the illustrated embodiment, in other embodiments, the first and second rotors may be positioned on opposite sides of the crop path.

The agricultural product removed from the crop collects on the spindles 30 of the rotors. In the illustrated embodiment, the row unit 18 includes a first doffer 42 that removes the agricultural product from the spindles 30 of the first rotor 26, and the row unit 18 includes a second doffer 44 that removes the agricultural product from the spindles 30 of the second rotor 28. Each doffer includes a stack of discs that engage the spindles 30 of the respective rotor to remove the agricultural product from the spindles 30. The number of discs of each doffer may be equal to the number of spindles on each spindle bar. As illustrated, the first doffer 42 rotates in a first doffer rotational direction 46, which is the same as the first rotor rotational direction 38, and the second doffer 44 rotates in a second doffer rotational direction 48, which is the same as the second rotor rotational direction 40. Each doffer rotates at a rotational speed that establishes a doffer tangential speed greater than a tangential speed of the spindles due to rotation of the spindles relative to the respective spindle bars. Accordingly, the interaction between the discs of the doffer and the spindles 30 of the respective rotor unwinds the agricultural product (e.g., seed cotton) from the spindles 30, thereby removing the agricultural product and directing the agricultural product to a respective conveying chamber. As illustrated, a first conveying chamber 50 is positioned adjacent to the first doffer 42, and a second conveying chamber 52 is positioned adjacent to the second doffer 44.

After the agricultural product is removed from the spindles 30 of the first rotor 26, the spindles 30 pass through a first moistener column assembly 54, and after the agricultural product is removed from the spindles 30 of the second rotor 28, the spindles 30 pass through a second moistener column assembly 56. Each moistener column assembly removes crop liquids (e.g., sap, etc.) from the spindles 30. In the illustrated embodiment, each moistener column assembly includes multiple moistener pad assemblies 58 distributed along the vertical axis of the row unit. The number of moistener pad assemblies 58 may be equal to the number of spindles 30 on each spindle bar. Each moistener pad assembly 58 includes a moistener pad 60 and a moistener pad holder 62 that supports the moistener pad 60. Each moistener column assembly also includes a moistener column 64 that directs cleaning fluid to each moistener pad assembly 58. The moistener pads 60 are positioned to engage respective spindles 30 as the respective rotor rotates, thereby applying the cleaning fluid to the spindles 30 and wiping the crop liquids off the spindles 30. As the rotors continue to rotate, the spindles 30 engage a subsequent crop at the crop path 34.

In the illustrated embodiment, the row unit 18 includes an airflow system 66 that drives the agricultural product to move from each conveying chamber toward an agricultural product outlet 68 of the row unit 18 (e.g., in combination with the air-assisted conveying system). As illustrated, the agricultural product outlet 68 is formed within a housing 67 of the row unit 18, and the housing 67 of the row unit 18 houses the rotors, the doffers, and the moister column assemblies. The air-assisted conveying system drives the agricultural product to move from the agricultural product outlet 68 of the row unit 18 to the accumulator. In certain embodiments, the air-assisted conveying system includes a tube coupled to the agricultural product outlet 68 of the row unit 18. Reduced air pressure within the tube in combination with air output by the airflow system 66 drives the agricultural product through the agricultural product outlet 68. The agricultural product then flows through the tube to the accumulator of the agricultural harvester. In the illustrated embodiment, the airflow system 66 includes a jet post 70 (e.g., first jet post) that receives air from an air source (e.g., the same air source that provides air to the air-assisted conveying system). The jet post 70 has an air outlet directed toward the agricultural product outlet 68, in which the air outlet outputs the air (e.g., in an air output direction 71) to drive the agricultural product toward the agricultural product outlet 68.

In addition, in the illustrated embodiment, the airflow system 66 includes an airflow path 72 extending from the jet post 70, in which the airflow path 72 receives the air from the jet post 70. The airflow path 72 is positioned below a floor of the row unit 18. Accordingly, the airflow path 72 does not interfere with the air output through the air outlet of the jet post 70. Furthermore, the airflow path 72 expels the air through at least one opening in the floor. The airflow system 66 also includes at least one louver 74 positioned remote from the air outlet of the jet post 70. The at least one louver 74 is coupled to the floor at the at least one opening, and the at least one louver 74 directs the air toward the agricultural product outlet 68. The additional air provided by the airflow path and directed toward the agricultural product outlet 68 by the at least one louver 74 may substantially reduce or eliminate the possibility of accumulation of the agricultural product within the row unit 18 (e.g., as compared to an airflow system that includes the jet post alone). As used herein with regard to directing the air, “toward the agricultural product outlet” refers to a direction along a path that leads to the agricultural product outlet (e.g., even if the path does not extend in a direction directly to the agricultural product outlet).

In the illustrated embodiment, the floor includes four openings, and the airflow system 66 includes four louvers 74. A first louver 76 is coupled to the floor at a first opening, and a second louver 78 is coupled to the floor at a second opening. The airflow path 72 expels the air through the first and second openings in the floor, and the first and second louvers 74 direct the air along a flow direction 80 (e.g., first flow direction) of the agricultural product from the second doffer 44 to the agricultural product outlet 68. Accordingly, the air provided by the airflow path 72 and directed toward the agricultural product outlet 68 by the first louver 76 and the second louver 78 facilitates flow of the agricultural product from the second doffer 44 to the agricultural product outlet 68 along the flow direction 80. While the airflow system 66 includes two louvers 74 that direct the air along the flow direction 80 in the illustrated embodiment, in other embodiments, the airflow system may include more or fewer louvers (e.g., 0, 1, 3, 4, or more) that direct the air along the flow direction of the agricultural product from the second doffer to the agricultural product outlet, and the floor may include a corresponding number of openings.

Furthermore, in the illustrated embodiment, a third louver 82 is coupled to the floor at a third opening. The airflow path 72 expels the air through the third opening in the floor, and the third louver 82 directs the air along a second flow direction 84 of the agricultural product from the first doffer 42 to the agricultural product outlet 68. Accordingly, the air provided by the airflow path 72 and directed toward the agricultural product outlet 68 by the third louver 82 facilitates flow of the agricultural product from the first doffer 42 to the agricultural product outlet 68 along the second flow direction 84. While the airflow system 66 includes one louver 74 that directs the air along the second flow direction 84 in the illustrated embodiment, in other embodiments, the airflow system may include more or fewer louvers (e.g., 0, 2, 3, 4, or more) that direct the air along the second flow direction of the agricultural product from the first doffer to the agricultural product outlet, and the floor may include a corresponding number of openings.

In addition, in the illustrated embodiment, a fourth louver 86 (e.g., second louver) is coupled to the floor at a fourth opening. The airflow path 72 expels the air through the fourth opening in the floor, and the fourth louver 86 directs the air crosswise to the flow directions 80, 84 (e.g., in a crosswise direction 87). Accordingly, the air provided by the airflow path 72 and directed toward the agricultural product outlet 68 by the fourth louver 86 may substantially reduce movement of the agricultural product into a cavity 88 within the row unit 18. While the airflow system 66 includes one louver 74 that directs the air crosswise to the flow directions 80, 84 in the illustrated embodiment, in other embodiments, the airflow system may include more or fewer louvers (e.g., 0, 2, 3, 4, or more) that direct the air crosswise to the flow directions disclosed above, and the floor may include a corresponding number of openings. The additional air provided by the airflow path 72 and directed toward the agricultural product outlet 68 by the louvers 74 may substantially reduce or eliminate the possibility of accumulation of the agricultural product within the row unit 18 (e.g., as compared to an airflow system that includes the jet post alone).

While the airflow system 66 includes two louvers 74 that direct the air along the flow direction 80, one louver 74 that directs the air along the second flow direction 84, and one louver 74 that directs the air crosswise to the flow directions 80, 84 in the illustrated embodiment, in other embodiments, the airflow system may include one or more louvers that direct the air in other suitable direction(s) (e.g., alone or in combination with any or all of the first, second, third, and fourth louvers disclosed above). For example, in certain embodiments, at least one louver may direct the air along a direction tangent to the first doffer, at least one louver may direct the air along a direction tangent to the second doffer, at least one louver may be positioned within the cavity of the row unit and directed toward the agricultural product outlet, or a combination thereof. In addition, while the floor includes four openings and the airflow system 66 includes four louvers 74 in the illustrated embodiment, in other embodiments, the floor may include more or fewer openings, and the airflow system may include more or fewer louvers (e.g., the number of louvers may be equal to the number of openings in the floor). For example, in certain embodiments, the floor may include 1, 2, 3, 5, 6, 7, 8, or more openings, and the airflow system may include a corresponding number of louvers.

Furthermore, while the airflow system includes one louver per floor opening in the embodiments disclosed above, in certain embodiments, the airflow system may include multiple louvers coupled to the floor at a single opening. For example, the airflow system may include two, three, four, or more louvers per opening for at least one opening. In addition, the opening may have any suitable length (e.g., 1 cm, 2 cm, 3 cm, 4 cm, 5 cm, 6 cm, 7 cm, 8 cm, 9 cm, 10 cm, 15 cm, 20 cm, 25 cm, 30 cm, etc.) and extend along any suitable portion of the floor. For example, in certain embodiments, an opening may extend from the second doffer to the agricultural product outlet, and/or an opening may extend from the first doffer to the agricultural product outlet. Furthermore, the louvers coupled to the floor at the single opening may direct the air in the same direction or in multiple directions. In addition, while each louver disclosed above directs the air in a single direction, in certain embodiments, at least one louver may direct the air in multiple directions (e.g., due to the shape and/or configuration of the louver).

Furthermore, while the airflow system 66 includes a single airflow path 72 in the illustrated embodiment, in other embodiments, the airflow system may include multiple airflow paths. For example, in certain embodiments, the airflow system may include multiple airflow paths, and each airflow path may extend from the jet post to a respective opening in the floor. In addition, in certain embodiments, the airflow system may include multiple airflow paths, in which each airflow path is fluidly coupled to the jet post (e.g., directly or via another airflow path) and expels the air through one or more openings in the floor.

In the illustrated embodiment, the airflow system 66 includes a second jet post 90 that receives air from an air source (e.g., the same air source as the first jet post or a different air source). The jet post 90 has an air outlet directed toward the agricultural product outlet 68 of the row unit 18, in which the air outlet outputs air (e.g., in a second air output direction 91) to drive the agricultural product toward the agricultural product outlet 68. In the illustrated embodiment, the second jet post 90 is positioned at an end of a barrier 92 that guides the agricultural product from the second doffer 44 toward the agricultural product outlet 68. However, in other embodiments, the jet post may be positioned at another suitable location within the row unit. The combination of the air provided by the second jet post 90, the air provided by the first jet post 70, and the air provided by the airflow path 72 and directed toward the agricultural product outlet 68 by the louver(s) 74 may substantially reduce or eliminate the possibility of accumulation of the agricultural product within the row unit 18 (e.g., as compared to an airflow system that includes a single jet post). In certain embodiments, the second jet post may be fluidly coupled to the airflow path, such that the airflow path receives the air from the second jet post. Furthermore, in certain embodiments, the airflow system may include a second airflow path extending from the second jet post, in which the second airflow path receives the air from the second jet post. The second airflow path may be positioned below the floor of the row unit, and the second airflow path may expel the air through at least one opening in the floor. In addition, at least one louver may be coupled to the floor at the at least one opening, and the at least one louver may direct the air toward the agricultural product outlet. While the airflow system 66 includes the second jet post 90 in the illustrated embodiment, in other embodiments, the second jet post may be omitted. Furthermore, in certain embodiments, the airflow system may include additional jet posts (e.g., third jet post, fourth jet post, etc.).

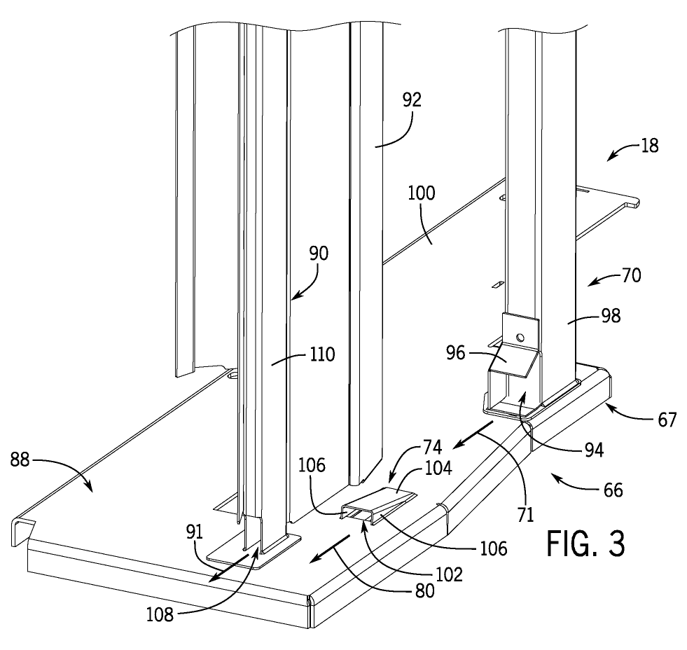

FIG. 3 is a perspective view of an embodiment of an airflow system 66 that may be employed within the row unit 18 of FIG. 2. As previously discussed, the airflow system 66 includes the jet post 70 (e.g., first jet post), and the jet post 70 receives air from an air source (e.g., the same air source that provides air to the air-assisted conveying system). As illustrated, the jet post 70 has an air outlet 94 directed toward the agricultural product outlet of the row unit 18. In the illustrated embodiment, the air outlet 94 is formed by a wall of the row unit housing and a nozzle 96 coupled to a body 98 of the jet post 70. However, in other embodiments, the air outlet may be formed by any other suitable structure(s), or the air outlet may only include an opening in the body of the jet post. As previously discussed, the airflow outlet 94 outputs the air (e.g., in the air output direction 71) to drive the agricultural product toward the agricultural product outlet.

As illustrated, the row unit 18 includes the floor 100, which is part of the housing 67, and a louver 74 is coupled to the floor 100. As previously discussed, the airflow path extends from the jet post 70, and the airflow path is positioned below the floor 100 of the row unit 18 (e.g., the opposite side of the floor from the rotors and doffers). The airflow path receives the air from the jet post 70, and the airflow path expels the air through an opening 102 in the floor. As illustrated, the louver 74 is positioned remote from the jet post 70, and the louver 74 is coupled to the floor 100 at the opening 102. The louver 74 may be coupled to the floor 100 via any suitable type(s) of connection(s), such as a fastener connection, a welded connection, an adhesive connection, other suitable type(s) of connection(s), or a combination thereof.

The louver 74 directs the air toward the agricultural product outlet, thereby facilitating movement of the agricultural product through the agricultural product outlet. The louver 74 may have any suitable width and any suitable length. In the illustrated embodiment, the louver 74 includes an air deflector 104 and side members 106 positioned on opposite sides of the air deflector 104. The air deflector 104 directs the air from the opening 102 toward the agricultural product outlet, and the side members 106 block flow of the air in directions crosswise to the direction of flow of the air toward the agricultural product outlet. In the illustrated embodiment, the louver 74 directs the air along the flow direction 80 of the agricultural product from the second doffer to the agricultural product outlet. Accordingly, the side members 106 block flow of the air in directions crosswise to the flow direction 80. While the louver 74 includes the side members 106 in the illustrated embodiment, in other embodiments, at least one side member (e.g., both side members) may be omitted.

While the floor 100 includes one opening 102 and the airflow system 66 includes one louver 74 in the illustrated embodiment, in other embodiments, the floor may include multiple openings, and the airflow system may include multiple louvers. The airflow control system may include any of the configurations disclosed above with regard to FIG. 2. For example, in certain embodiments, the airflow system includes two louvers that direct the air along the flow direction of the agricultural product from the second doffer to the agricultural product outlet, one louver that directs the air along the second flow direction of the agricultural product from the first doffer to the agricultural product outlet, and one louver that directs the air crosswise to the flow directions. Furthermore, while the airflow system 66 includes one airflow path in the illustrated embodiment, in other embodiments, the airflow system may include any suitable number of airflow paths, as disclosed above with reference to FIG. 2.

As previously discussed, the airflow system 66 includes the second jet post 90, and the second jet post 90 is positioned at an end of the barrier 92 that guides the agricultural product from the second doffer toward the agricultural product outlet. However, in other embodiments, the second jet post may be positioned at another suitable location within the row unit. Furthermore, the second jet post 90 receives air from an air source (e.g., the same air source as the first jet post 70 or a different air source). As illustrated, the jet post 90 has an airflow outlet 108 directed toward the agricultural product outlet of the row unit 18. In the illustrated embodiment, the airflow outlet 108 only includes an opening in a body 110 of the second jet post 90. However, in other embodiments, the air outlet may be formed by a nozzle or other suitable structure(s). As previously discussed, the airflow outlet 108 outputs the air (e.g., in the second air output direction 91) to drive the agricultural product toward the agricultural product outlet. Furthermore, in certain embodiments, the second jet post may be fluidly coupled to the airflow path, and/or a second airflow path may extend from the second jet post, as disclosed above with reference to FIG. 2. While the airflow system 66 includes the second jet post 90 in the illustrated embodiment, in other embodiments, the second jet post may be omitted. Furthermore, in certain embodiments, the airflow system may include additional jet posts (e.g., third jet post, fourth jet post, etc.).

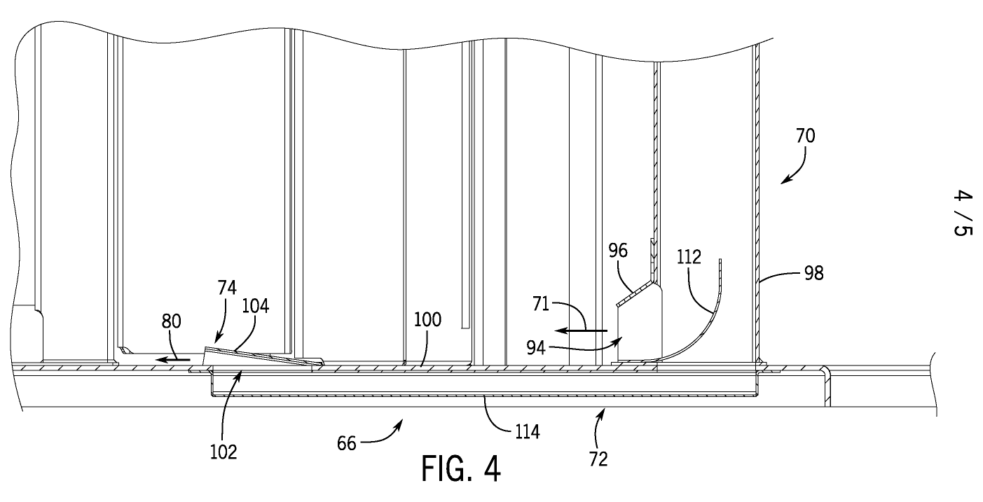

FIG. 4 is a cross-sectional view of a portion of the airflow system 66 of FIG. 3. As previously discussed, the jet post 70 receives air from the air source, and the airflow outlet 94 outputs the air (e.g., in the air output direction 71) to drive the agricultural product toward the agricultural product outlet. Furthermore, the airflow path 72 extends from the jet post 70 and receives the air from the jet post 70. As illustrated, the airflow path 72 is positioned below the floor 100 of the row unit, and the airflow path 72 expels the air through the opening 102 in the floor 100. The louver 74 is positioned remote from the air outlet 94 of the jet post 70, the louver 74 is coupled to the floor 100 at the opening 102, and the louver 74 directs the air toward the agricultural product outlet (e.g., in the flow direction 80 of the agricultural product from the second doffer to the agricultural product outlet).

In the illustrated embodiment, the airflow system 66 includes a splitter 112 disposed within the jet post 90. The splitter 112 directs a first portion of the air from the air source through the air outlet 94 of the jet post 70, and the splitter 112 directs a second portion of the air from the air source through the airflow path 72. The shape of the splitter 112 may be selected to reduce a pressure drop of the air as the air flows around the splitter to the air outlet 94 and to the airflow path 72. Furthermore, the shape of the splitter 112 may be selected to establish a desired mass air flow rate ratio between the first portion and the second portion of the air. While the airflow system 66 includes the splitter 112 in the illustrated embodiment, in other embodiments, the splitter may be omitted. Furthermore, in the illustrated embodiment, the floor 100 forms an upper wall of the airflow path 72, and a channel 114 forms the bottom and side walls of the airflow path 72. However, in certain embodiments, the airflow path may be formed by a conduit positioned below the floor. Furthermore, in the illustrated embodiment, the airflow path 72 has a rectangular cross-sectional shape. However, in other embodiments, the airflow path may have another suitable cross-sectional shape (e.g., circular, elliptical, triangular, etc.).

In the embodiments disclosed above, the airflow path(s) are positioned entirely below the floor of the row unit. However, in certain embodiments, at least a portion of at least one airflow path may be positioned above the floor of the row unit. For example, in certain embodiments, a first portion of an airflow path may be positioned below the floor, and a second portion of the airflow path may be positioned above the floor. Furthermore, in certain embodiments, an entirety of at least one airflow path may be positioned above the floor. In addition, in the embodiments disclosed above, each airflow path extends from a jet post and receives the air from the jet post. However, in certain embodiments, at least one airflow path may not extend from a jet post (e.g., the at least one airflow path may not be fluidly coupled to a jet post). In such embodiments, the at least one airflow path may be fluidly coupled to an air source (e.g., the same air source that provides the air to the jet post(s) or a different air source), and the airflow path may receive the air from the air source. Furthermore, in certain embodiments, an airflow path may extend from a jet post, and the airflow path may be fluidly coupled to an air source (e.g., the same air source that provides the air to the jet post or a different air source). In such embodiments, the airflow path may receive air from the jet post and the air source.

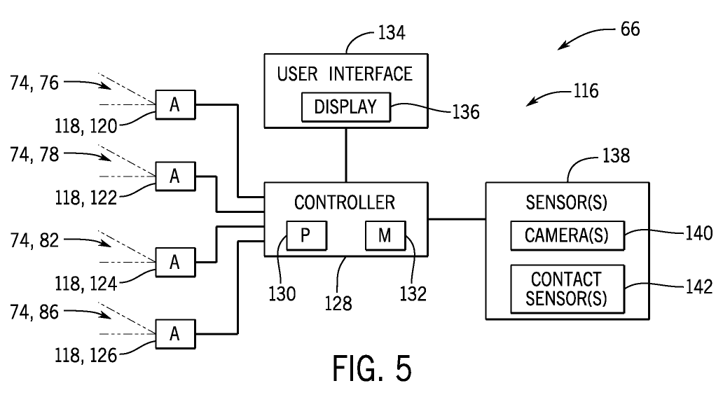

FIG. 5 is a block diagram of an embodiment of an airflow control system 116 that may be employed within the airflow system 66 of FIG. 3. In the illustrated embodiment, the airflow control system 116 includes actuators 118 that drive the louvers 74 to move between open and closed positions. While each louver 74 is in the open position, the louver 74 directs the air toward the agricultural product outlet, and while each louver 74 is in the closed position, the louver 74 blocks flow of the air through the respective opening. In certain embodiments, each louver 74 rotates between the closed position, in which the louver 74 covers the opening, and the open position, in which the louver 74 is angled upwardly from the opening, thereby directing the air toward the agricultural product outlet. For example, each louver 74 may be pivotally coupled to the floor at the opening by a respective pivot joint, and each louver 74 may be driven to rotate between the open and closed positions by a respective actuator 118. Furthermore, in certain embodiments, at least one louver (e.g., each louver) may be translatably coupled to the floor at the opening, and the at least one louver may be driven to translate between the open and closed positions by a respective actuator.

In the illustrated embodiment, the airflow control system 116 includes a first actuator 120 that drives the first louver 76 to move between the open and closed positions, a second actuator 122 that drives the second louver 78 to move between the open and closed positions, a third actuator 124 that drives the third louver 82 to move between the open and closed positions, and a fourth actuator 126 that drives the fourth louver 86 (e.g., second louver) to move between the open and closed positions. Each actuator 118 may include any suitable type(s) of actuation device(s), such as electric motor(s), electric linear actuator(s), pneumatic cylinder(s), pneumatic motor(s), hydraulic cylinder(s), hydraulic motor(s), etc. While the airflow control system 116 includes four actuators 118 in the illustrated embodiment, in other embodiments, the airflow control system may include more or fewer actuators (e.g., one actuator for each louver). Furthermore, in certain embodiments, at least one actuator (e.g., each actuator) may drive multiple louvers to move between the open and closed positions (e.g., via a linkage assembly).

In the illustrated embodiment, the airflow control system 116 includes a controller 128 communicatively coupled to each actuator 118 (e.g., directly communicatively coupled to electric actuator(s), communicatively coupled to fluid actuator(s) via a valve assembly, etc.). In certain embodiments, the controller 128 is an electronic controller having electrical circuitry that controls each actuator 118. In the illustrated embodiment, the controller 128 includes a processor 130, such as a microprocessor, and a memory device 132. The controller 128 may also include one or more storage devices and/or other suitable components. The processor 130 may be used to execute software, such as software for controlling the actuators 118, and so forth. Moreover, the processor 130 may include multiple microprocessors, one or more “general-purpose” microprocessors, one or more special-purpose microprocessors, and/or one or more application specific integrated circuits (ASICs), or some combination thereof. For example, the processor 130 may include one or more reduced instruction set (RISC) processors.

The memory device 132 may include a volatile memory, such as random access memory (RAM), and/or a nonvolatile memory, such as read-only memory (ROM). The memory device 132 may store a variety of information and may be used for various purposes. For example, the memory device 132 may store processor-executable instructions (e.g., firmware or software) for the processor 130 to execute, such as instructions for controlling the actuators 118, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the actuators 118, etc.), and any other suitable data. The controller may be positioned at any suitable location(s) on the agricultural harvester (e.g., as one element in one location or as multiple elements in multiple locations).

In the illustrated embodiment, the airflow control system 116 includes a user interface 134 communicatively coupled to the controller 128. The user interface 134 receives input from an operator and provides information to the operator. The user interface 134 may include any suitable input device(s) for receiving input, such as a keyboard, a mouse, button(s), switch(es), knob(s), other suitable input device(s), or a combination thereof. In addition, the user interface 134 may include any suitable output device(s) for presenting information to the operator, such as speaker(s), indicator light(s), other suitable output device(s), or a combination thereof. In the illustrated embodiment, the user interface 134 includes a display 136 that presents visual information to the operator. In certain embodiments, the display 136 may include a touchscreen interface that receives input from the operator.

In the illustrated embodiment, the airflow control system 116 includes one or more sensors 138, and each sensor 138 outputs a sensor signal indicative of accumulation of the agricultural product within the row unit (e.g., between the second doffer and the agricultural product outlet, between the first doffer and the agricultural product outlet, within the cavity, etc.). As illustrated, the sensor(s) 138 are communicatively coupled to the controller 128. The controller 128 receives the sensor signal(s) from the sensor(s) 138, and the controller 128 detects plugging within the row unit based on the accumulation of the agricultural product within the row unit. For example, in response to determining that the accumulation of the agricultural product within the row unit is greater than a threshold accumulation, the controller may detect plugging within the row unit. Furthermore, the controller 128 controls at least one actuator 118 to move at least one respective louver 74 to the open position (e.g., from the closed position to the open position) in response to detecting the plugging within the row unit. As previously discussed, with the louver(s) 74 in the open position, the louver(s) direct air from the opening(s) in the floor of the row unit toward the agricultural product outlet of the row unit. The additional air directed by the louver(s) 74 toward the agricultural product outlet may drive the agricultural product through the agricultural product outlet, thereby substantially reducing or eliminating the accumulation of the agricultural product within the row unit. In certain embodiments, the controller 128 also controls the actuator(s) 118 to move the respective louver(s) 74 to the closed position (e.g., from the open position to the closed position) in response to termination of the detection of the plugging within the row unit.

In certain embodiments, the sensor(s) 138 may include one or more cameras 140. Each camera 140 may be directed toward a region within the row unit. For example, the camera may be positioned above the region and directed downwardly, or the camera may be positioned to a side of the region and directed toward the region. Each camera outputs a sensor signal indicative of an image of the region. The image is indicative of accumulation of agricultural product within the region while agricultural product accumulates within the region. The sensor(s) 138 may include any suitable number of cameras 140 (e.g., 0, 1, 2, 3, 4, 5, 6, or more). For example, in certain embodiments, one camera 140 may be directed toward the region between the second doffer and the agricultural product outlet, another camera 140 may be directed toward the region between the first doffer and the agricultural product outlet, and a further camera 140 may be directed toward the region of the cavity. While the sensor(s) 138 include camera(s) 140 in the illustrated embodiment, in other embodiments, the camera(s) may be omitted.

Furthermore, in the illustrated embodiment, the sensor(s) 138 include contact sensor(s) 142. Each contact sensor 142 may be positioned within a region of the row unit, and each contact sensor 142 may output the sensor signal indicative of accumulation of the agricultural product within the region in response to contact between the agricultural product and the contact sensor 142. The sensor(s) 138 may include any suitable number of contact sensors 142 (e.g., 0, 1, 2, 3, 4, 5, 6, or more). For example, in certain embodiments, one contact sensor 142 may be disposed within the region between the second doffer and the agricultural product outlet, another contact sensor 142 may be disposed within the region between the first doffer and the agricultural product outlet, and a further contact sensor 142 may be disposed within the region of the cavity. While the sensor(s) 138 include contact sensor(s) 142 in the illustrated embodiment, in other embodiments, the contact sensor(s) may be omitted. Furthermore, in certain embodiments, the sensor(s) may include any other suitable sensor(s) that monitor accumulation within the row unit, such as capacitance sensor(s), RADAR sensor(s), LiDAR sensor(s), ultrasonic sensor(s), other suitable type(s) of sensor(s), or a combination thereof.

In certain embodiments, the controller 128 controls the actuators 118 collectively. For example, in response to the controller 128 detecting plugging within the row unit (e.g., within any region of the row unit, based on feedback from any sensor 138), the controller 128 may control all of the actuator(s) 118 to move the respective louver(s) 74 to the open position. Furthermore, in certain embodiments, the controller 128 controls the actuators 118 in groups, in which each group is associated with louver(s) 74 within a respective region of the row unit. For example, in response to the controller 128 detecting plugging within one region (e.g., based on feedback from contact sensor(s) 142 disposed within the region, based on feedback from camera(s) 140 directed toward the region, etc.), the controller 128 may control the actuator(s) 118 associated with the louver(s) within the region to move the louver(s) to the open position. In addition, in certain embodiments, the controller 128 controls the actuators 118 independently. For example, in response to the controller 128 detecting plugging downstream from a louver 74, the controller 128 may control the actuator 118 associated with the louver 74 to move the louver 74 to the open position.

In certain embodiments, the controller 128 controls each actuator 118 based on a degree of plugging within the row unit or within a respective region of the row unit. For example, in response to detecting plugging within the row unit/region of the row unit, the controller 128 may determine the degree of plugging based on feedback from the sensor(s) 138. In response to determining a larger degree of plugging, the controller 128 may control the respective actuator(s) 118 to move the respective louver(s) 74 to a more open position (e.g., fully open position). In addition, in response to determining a smaller degree of plugging, the controller 128 may control the respective actuator(s) 118 to move the respective louver(s) 74 to a less open position (e.g., partially open position).

In certain embodiments, the controller 128 may control the user interface 134 to present an indication of plugging (e.g., a visual indication on the display 136) in response to detecting plugging within the row unit. Furthermore, in embodiments having multiple sensors 138, the controller 128 may control the user interface 134 to present an indication (e.g., a visual indication on the display 136) of the location of the plugging (e.g., the region where the plugging is present). In addition, in embodiments in which the sensor(s) 138 include camera(s) 140, the controller 128 may control the display 136 of the user interface 134 to present image(s) of the region(s) monitored by the camera(s) 140. Furthermore, in certain embodiments, the user interface 134 may receive user input indicative of instructions to control the actuator(s) 118. In such embodiments, in response to receiving the instructions from the user, the user interface 134 may output a signal indicative of the instructions to the controller 128, and the controller 128, in turn, may control the actuator(s) 118 based on the instructions. While each louver 74 may be controlled by an actuator 118 in the illustrated embodiment, in certain embodiments, at least one louver (e.g., each louver of the airflow system) may be fixed (e.g., not controlled by an actuator).

In certain embodiments, the controller controls an airflow rate through each airflow path. For example, in certain embodiments, a valve may be positioned upstream of the airflow path (e.g., between the jet post and the airflow path) or within the airflow path upstream of the opening(s). In such embodiments, an actuator may be coupled to each valve, and each actuator may be communicatively coupled to the controller. The controller may control the valves to control the airflow rate through each airflow path. Furthermore, in certain embodiments, the controller may be communicatively coupled to the air source(s) that provide the air to the airflow path(s) (e.g., through respective jet post(s) and/or directly to the airflow path(s)). In such embodiments, the controller may control the air source(s) to control the airflow rate(s) through the airflow path(s). In certain embodiments, the controller may control the airflow rate(s) through the airflow path(s) based on feedback from the sensor(s). For example, in response to detecting plugging within the row unit/region of the row unit, the controller may increase the airflow rate(s) through one or more airflow paths. In addition, in response to termination of detection of the plugging, the controller may decrease the airflow rate(s).

Furthermore, in certain embodiments, the controller controls which jet post(s) and/or which airflow path(s) receive the air. For example, a valve may be positioned upstream of each jet post and/or upstream of each airflow path. An actuator may be coupled to each valve, and each actuator may be communicatively coupled to the controller. The controller may control the valves to control which jet post(s) and/or which airflow path(s) receive the air (e.g., based on feedback from the sensor(s)). For example, in response to detecting plugging within the row unit/region of the row unit, the controller may open one or more valves to provide air to the row unit/region of the row unit. In addition, in response to termination of detection of the plugging, the controller may closed the valve(s).

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical.

1. An airflow system of a row unit of an agricultural harvester, comprising:
a jet post that receives air from an air source, wherein the jet post has an air outlet directed toward an agricultural product outlet of the row unit, and the air outlet outputs the air to drive agricultural product toward the agricultural product outlet;
an airflow path extending from the jet post, wherein the airflow path receives the air from the jet post, the airflow path is positioned below a floor of the row unit, and the airflow path expels the air through at least one opening in the floor; and
at least one louver positioned remote from the air outlet of the jet post, wherein the at least one louver is coupled to the floor at the at least one opening, and the at least one louver is directed to the air toward the agricultural product outlet.

2. The airflow system of claim 1, wherein the at least one opening in the floor comprises a plurality of openings in the floor, and the at least one louver comprises a plurality of louvers.

3. The airflow system of claim 2, wherein the plurality of louvers comprises:
a first louver that directs the air along a first flow direction of the agricultural product from a doffer to the agricultural product outlet;
a second louver that directs the air crosswise to the first flow direction;
a third louver that directs the air along a second flow direction of the agricultural product from another doffer to the agricultural product outlet; or
a combination thereof.

4. The airflow system of claim 2, wherein each of the plurality of louvers directs the air along a flow direction of the agricultural product from a doffer to the agricultural product outlet.

5. The airflow system of claim 1, comprising at least one actuator that drives the at least one louver to move between an open position and a closed position, wherein the at least one louver directs the air toward the agricultural product outlet while in the open position, and the at least one louver blocks flow of the air through the at least one opening while in the closed position.

6. The airflow system of claim 5, comprising a controller communicatively coupled to the at least one actuator, wherein the controller comprises a processor and a memory, and the controller controls the at least one actuator to move the at least one louver between the open position and the closed position.

7. The airflow system of claim 6, comprising a sensor that outputs a sensor signal indicative of an accumulation of the agricultural product within the row unit, wherein the sensor is communicatively coupled to the controller, and the controller:
detects plugging within the row unit based on the accumulation of the agricultural product within the row unit; and
controls the at least one actuator to move the at least one louver to the open position in response to detecting the plugging within the row unit.

8. The airflow system of claim 7, wherein the sensor comprises a camera, a contact sensor, or a combination thereof.

9. A row unit of an agricultural harvester, comprising:
an agricultural product outlet that expels agricultural product from the row unit to a duct;
a floor; and
an airflow system, comprising:
a jet post that receives air from an air source, wherein the jet post has an air outlet positioned at the floor and directed toward the agricultural product outlet, and the air outlet outputs the air to drive the agricultural product toward the agricultural product outlet;
an airflow path extending from the jet post, wherein the airflow path receives the air from the jet post, the airflow path is positioned below the floor, and the airflow path expels the air through at least one opening in the floor; and
at least one louver positioned remote from the air outlet of the jet post, wherein the at least one louver is coupled to the floor at the at least one opening, and the at least one louver directs the air toward the agricultural product outlet.

10. The row unit of claim 9, wherein the at least one opening in the floor comprises a plurality of openings in the floor, and the at least one louver comprises a plurality of louvers.

11. The row unit of claim 10, wherein the plurality of louvers comprises:
a first louver that directs the air along a first flow direction of the agricultural product from a doffer to the agricultural product outlet;
a second louver that directs the air crosswise to the first flow direction;
a third louver that directs the air along a second flow direction of the agricultural product from another doffer to the agricultural product outlet; or
a combination thereof.

12. The row unit of claim 10, wherein each of the plurality of louvers directs the air along a flow direction of the agricultural product from a doffer to the agricultural product outlet.

13. The row unit of claim 9, wherein the airflow control system comprises at least one actuator that drives the at least one louver to move between an open position and a closed position, the at least one louver directs the air toward the agricultural product outlet while in the open position, and the at least one louver blocks flow of the air through the at least one opening while in the closed position.

14. The row unit of claim 13, wherein the airflow system comprises a controller communicatively coupled to the at least one actuator, the controller comprises a processor and a memory, and the controller controls the at least one actuator to move the at least one louver between the open position and the closed position.

15. The row unit of claim 14, wherein the airflow system comprises a sensor that outputs a sensor signal indicative of an accumulation of the agricultural product within the row unit, the sensor is communicatively coupled to the controller, and the controller:
detects plugging within the row unit based on the accumulation of the agricultural product within the row unit; and
controls the at least one actuator to move the at least one louver to the open position in response to detecting the plugging within the row unit.

16. The row unit of claim 15, wherein the sensor comprises a camera, a contact sensor, or a combination thereof.

17. An airflow control system of a row unit of an agricultural harvester, comprising:
a controller comprising a processor and a memory, wherein the controller:
receives a sensor signal indicative of accumulation of agricultural product within the row unit;
detects plugging within the row unit based on the accumulation of the agricultural product within the row unit; and
controls an actuator to move a louver from a closed position to an open position in response to detecting the plugging within the row unit, wherein the louver directs air from an opening in a floor of the row unit toward an agricultural product outlet of the row unit while in the open position, and the louver blocks flow of the air through the opening while in the closed position.

18. The airflow control system of claim 17, wherein the opening receives the air from an airflow path positioned below the floor, the airflow path receives the air from a jet post, and the airflow path expels the air through the opening.

19. The airflow control system of claim 17, comprising a sensor that outputs the sensor signal, wherein the sensor is communicatively coupled to the controller, and the sensor comprises a camera, a contact sensor, or a combination thereof.

20. The airflow control system of claim 17, comprising the actuator, wherein the actuator is communicatively coupled to the controller, and the actuator drives the louver to move between the open position and the closed position.
